(19) United States
(12) Patent Application Publication
(10) Pub. No.: US 2005/0192911 A1
(43) Pub. Date: Sep. 1, 2005

(54) Application program interface for postal security device

(76) Inventor: James M. Mattern, Bethany, CT (US)

Correspondence Address: PERMAN & GREEN, 425 POST ROAD, FAIRFIELD, CT, 06824, US

(21) Appl. No.: 11/047,287

(22) Filed: Jan. 31, 2005

Related U.S. Application Data
(63) Continuation-in-part of application No. 10/678,898, filed on Oct. 2, 2003, now Pat. No. 6,856,172.

(51) Int. Cl. G06F 17/60

(52) U.S. Cl. 705/401; 705/406

(57) ABSTRACT

An application program interface includes a function for adding a communication port for one or more PSD's and automatically initializing the one or more PSD's, a function adding an indicia stream to the one or more initialized PSD's to cause the one or more initialized PSD's to generate an indicia string, a function for activating or deactivating the indicia stream, and a function for enabling an automatic funds download to the one or more initialized PSD's.

### This application is a continuation in part of co-pending U.S. application Ser. No. 10/678,898, filed Jan. 30, 2004, which is incorporated by reference herein in its entirety.

### BACKGROUND

The present to postal security devices and, more particularly, to an application program interface for controlling postal security devices.

### BRIEF DESCRIPTION OF RELATED DEVELOPMENTS

In general, postal security devices (PSD's) are controlled by complex software. It would be advantageous to provide a high level interface between one or more PSD's and an application developer.

### SUMMARY OF THE EXEMPLARY EMBODIMENTS

The exemplary embodiments disclosed herein are directed to an application program interface for controlling one or more postal security devices in a system for producing indicia. The Application program interface includes a function for adding a communication port for one or more PSD's and automatically initializing the one or more PSD's, a function adding an indicia stream to the one or more initialized PSD's to cause the one or more initialized PSD's to generate an indicia string, a function for activating or deactivating the indicia stream, and a function for enabling an automatic funds download to the one or more initialized PSD's.

### BRIEF DESCRIPTION OF THE DRAWINGS

The foregoing aspects and other features of the disclosed embodiments are explained in the following description, taken in connection with the accompanying drawings, wherein:

FIG. 1 shows an example of how a web developer would create indicia;

FIG. 2 shows a system according to the present invention and the general operations provided by an API incorporating features of the disclosed embodiments;

FIG. 3 shows exemplary functions performed by the API;

FIG. 4 shows an example of an automated funds download function; and

FIGS. 5-16 show examples of screens and functions presented by the API to a user.

### DETAILED DESCRIPTION OF THE EXEMPLARY EMBODIMENTS

Although the exemplary embodiments will be described with reference to the drawings, it should be understood that the exemplary embodiments may be embodied in many alternate forms. In addition, any suitable size, shape or type of elements or materials could be used.

The exemplary embodiments disclosed herein are directed to a high level application program interface (API) that provides low level communication between one or more PSD's, also referred to as SAFE's, and an application developer. In another embodiment, the present invention also provides low level communication between a PSD and a service provider infrastructure.

The present invention is compatible with a variety of development environments such as web pages, for example, Active Server Pages or complied languages for example, Visual C++ or Visual Basic. The process of creating indicia is the same generally across environments but the means of extrapolating data may be different. A developer gathers rate information, recipient address, etc. then submits this information to a PSD through the present invention, which validates the incoming data, creates an indicia stream, and returns that stream to the developer. The developer can then return that stream to a client and create an image on the client's computer or create the image on a server and return the image to the client.

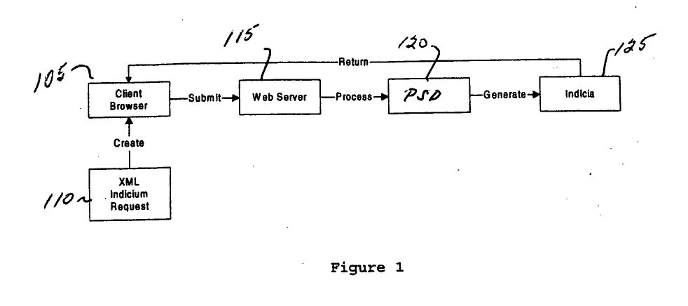

An example of how a web developer would create indicia is shown in FIG. 1. A user browses a web page and selects a postage generating service 105. Selection of this service constructs an XML indicia request 110 and submits the request to a Web Server 115. The Web Server 115 processes the XML request, and submits it to a PSD, also referred to as a SAFE 120. The SAFE 120 generates indicia 125, which is returned to the user through the browser 105.

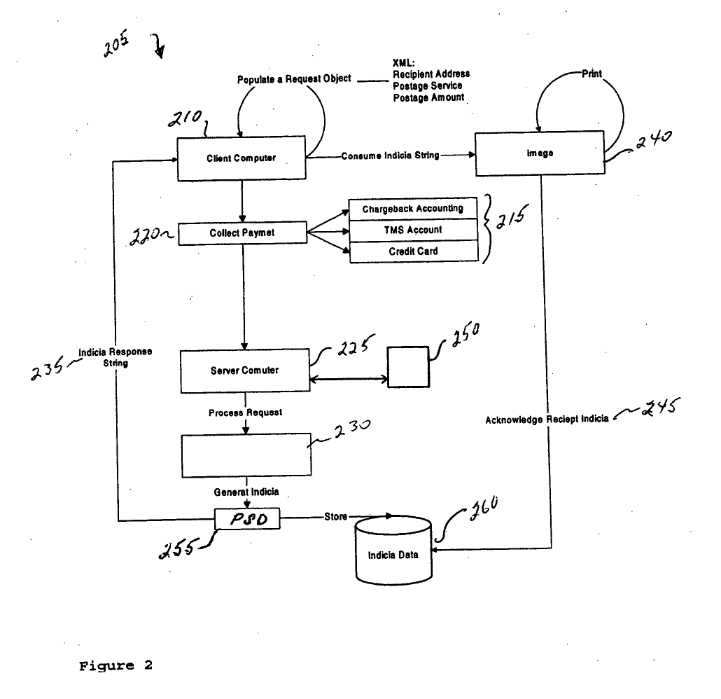

The primary components of the API 200 are shown in a postal service infrastructure 205 as illustrated in FIG. 2. The API 200 may include an image maker routine, or program 240, which may be a Common Object Model (COM) Dynamic Link Library (DLL) built on an Active Template Library (ATL). The image maker routine 240 is generally installed a client computer 210 and operates to convert an indicia string into a JPEG, Bitmap, or other file image for printing.

The API 200 may also include a control program 250, which may be a COM service built on ATL to be used by a server 225. This control program 250 maintains and regulates the activities of one or more PSD's 255. The activities may generally include indicia creation, postage download, and server configuration.

The API 200 may further include a PSD Agent 230 which may also be a COM component built on ATL and may be used by the control program 250 to service a number of PSD's 255. The PSD Agent 230 may not be directly accessible by a developer.

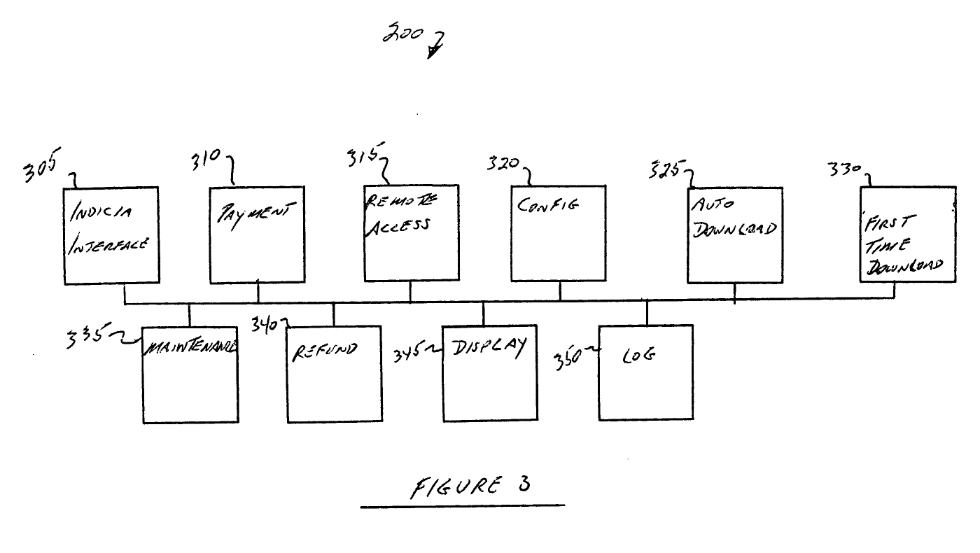

The API generally utilizes the image maker routine 240, control program 250, and PSD Agent 230 to provide the functions shown in FIG. 3. An indicia creation interface 305 controls the implementation process of creating indicia that represents postage and a system of payment. Indicia creation rates may be in excess of 18,000 per hour. A payment process 310 includes downloading funds into the PSD's from a service provider's infrastructure for indicia printing. Remote access configuration 315 may include specifying a RAS phonebook connection or a network card, and specifying port and IP address of a service provider's server. A configuration function 320 may include computer selection, adding and specifying communication ports, and activating or deactivating PSD's by use of a Personal Identification Number (PIN) logon. An automated download function 325 provides automated downloads according to predetermined threshold amounts. A first time download function 330 provides an initial funds download to prime a PSD for indicia printing. A maintenance function 335 provides a connection to a service provider infrastructure for automated software upgrades, resetting of timers, etc. A refund process 340 removes a PSD from operations and refunds any remaining postage contained by the PSD. This operation renders the PSD inoperable. An information display function 345 provides a visual representation of a PSD's condition, including funds available, descending and ascending registers, battery expiration, etc. Log facilities 350 provide different levels of log tracing which may include event tracing, event logging, and error tracking.

The API may be implemented using COM and may support languages such as Visual C++, Visual Basic and Active Server Pages (ASP).

The API may control PSD's across a distributed system, for example the API may reside on one system, while a number of PSD's under control of the API may reside on another system connected by a network.

Referring again to FIG. 2, in order to begin operations, the control program 250 generally configures a set of COM ports to communicate with the PSD's 255 before operations are started. An account 215 on the service provider infrastructure for downloading funds for each PSD is generally established. The control program 250 generally provides individual PIN numbers for each PSD. A PSD will generally not store these values and will require them each time the PSD is logged onto. An automated funds download threshold is usually supplied before operations are started.

A user provides information such as an address, type of service, and postage amount through client computer 210. A method of payment is selected from the user's account 215 and a payment is collected 220. The server 225 controlling the one or more PSD's 255 processes an indicia request through the PSD Agent 230 to a PSD 255. An indicia bit stream or image 235 is sent to the client computer 210 and the image is printed by the image maker routine 240. An acknowledgement that the image has been printed 245 is stored in a database 260 for recording purposes.

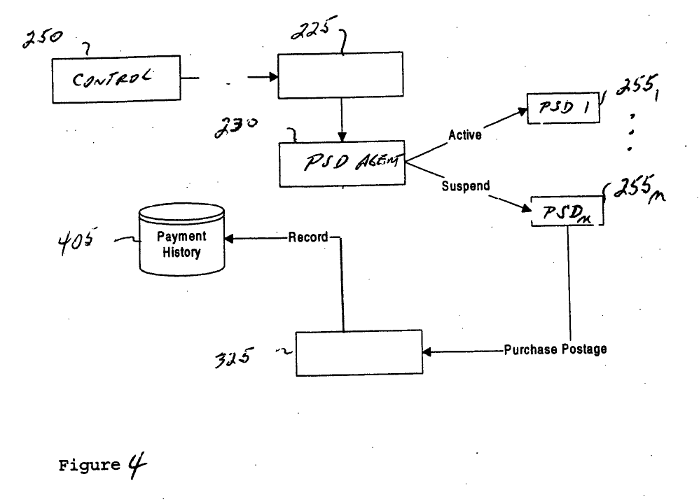

In addition to general operations, the API 200 also provides for funds downloading in the event that a PSD 255 runs low on funds. An exemplary implementation of the automated download function 325 (FIG. 3) is shown in FIG. 4. The control program 250 configures funds downloading through the server 225 and PSD Agent 230, including setting a funding threshold for a number of PSD's 255. When a PSD 255ₙ reaches the threshold, the PSD Agent 230 suspends operations for the PSD 255ₙ and starts the automated download function 325. Upon a successful funds download, automated download function 325 updates a download history database 405.

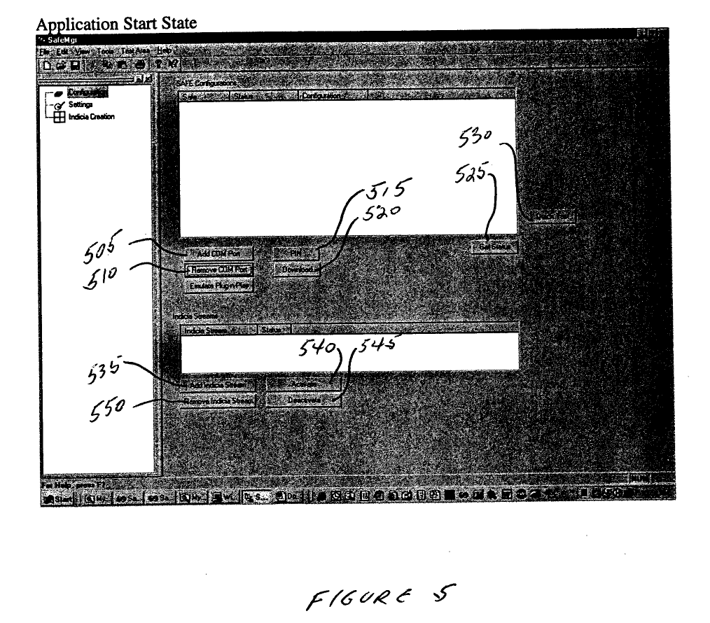

Detailed operations and examples of screens presented to a user as part of the API will now be explained. On startup of the API, the user is presented with a screen as shown in FIG. 5. Upon initialization, the API provides a user with the ability to add COM ports 505 for PSD's, remove COM ports 510, enter a PIN 515, performa funds download 520, perform a quick test 530, get the status of a PSD 525 and to test a PSD 530. The API also provides the ability to add an indicia stream 535, activate 540, deactivate 545, or remove 550 an indicia stream.

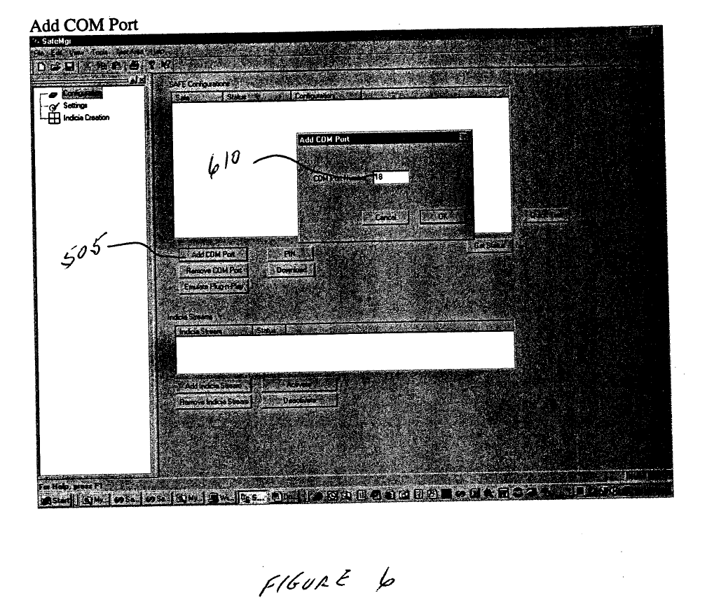

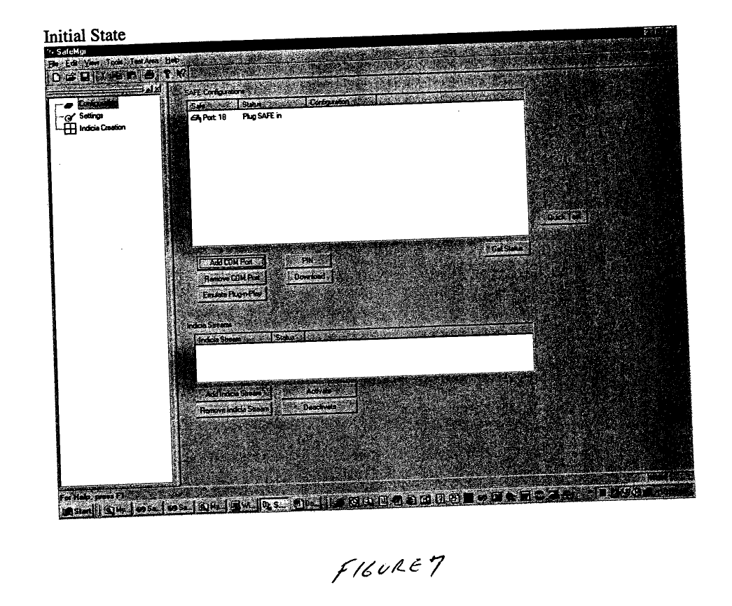

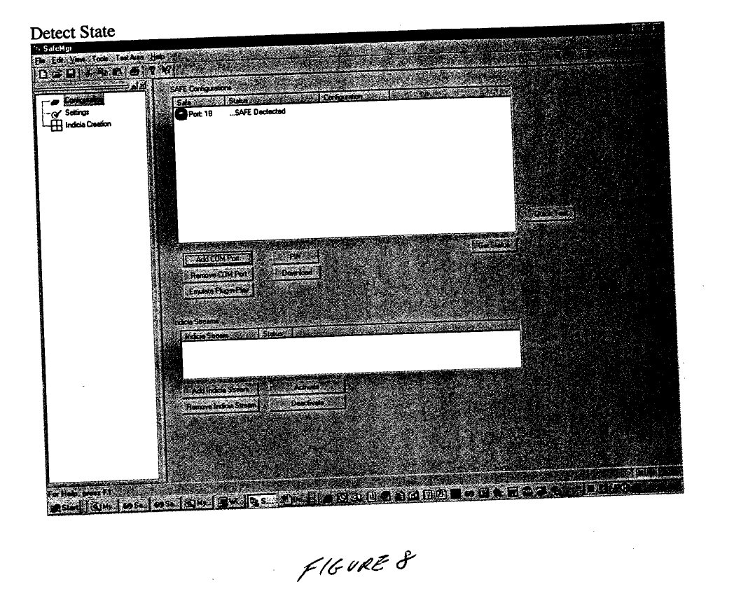

As shown in FIG. 6, pressing the Add COM Port button 505 allows a user to configure a PSD COM port by entering a COM port number 610. Once the COM port number 610 has been entered, the API directs the user to plug in the respective PSD, also referred to as a SAFE, as shown in FIG. 7. The API, through the control program 250 and PSD Agent 230, interrogates the COM port until a PSD is detected and then notifies the user as shown in FIG. 8.

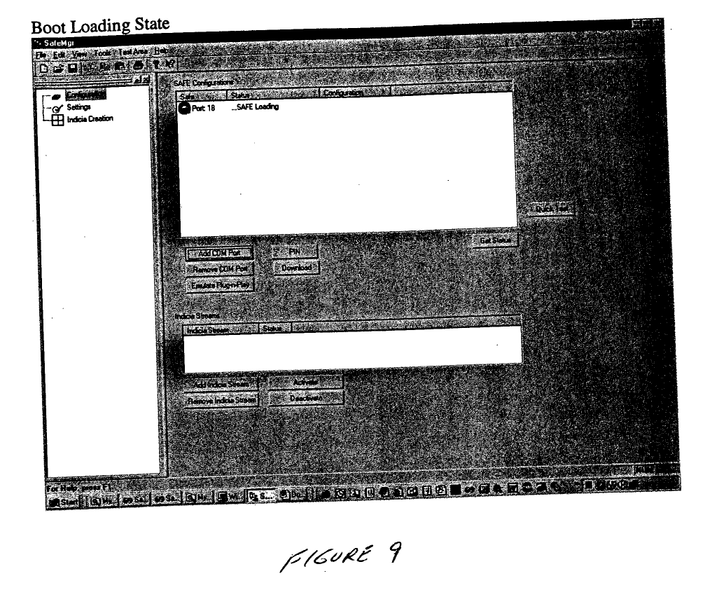

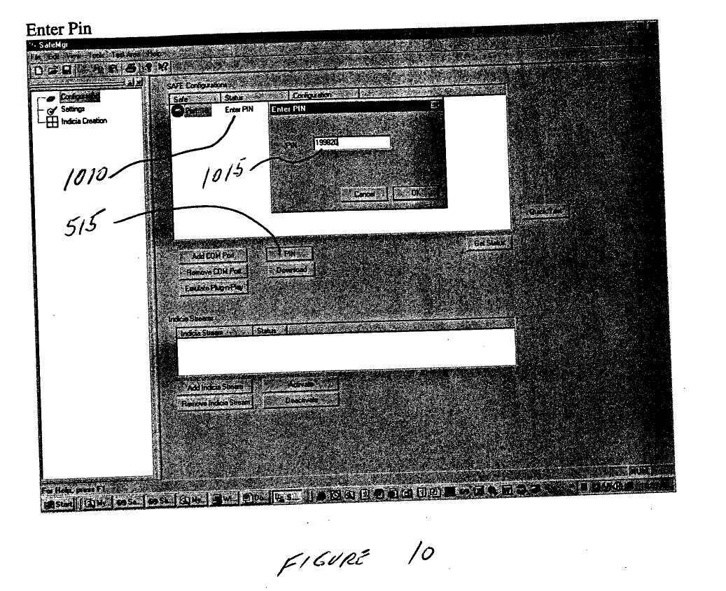

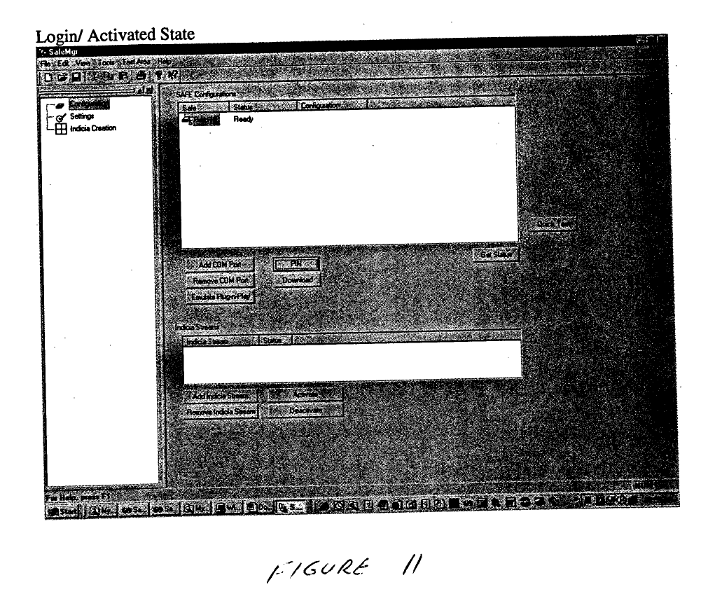

As shown in FIG. 9, the API, again through the control program 250 and PSD Agent 230 initializes and loads programs into the PSD. Turning to FIG. 10, once the PAD is initialized and loaded, the API requests the PIN for the PSD 1010. The user then presses the PIN button 515 and enters the PIN 1015 in the space provided. As shown in FIG. 11, once a valid PIN is entered the PSD is ready to produce indicia.

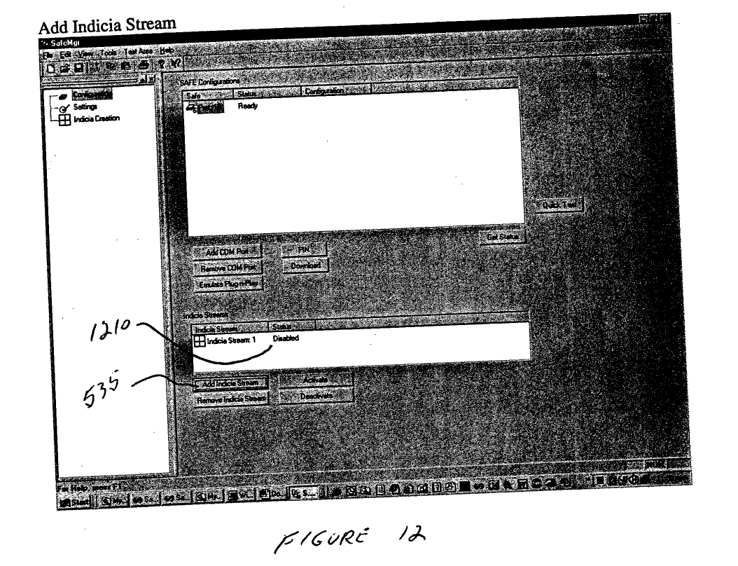

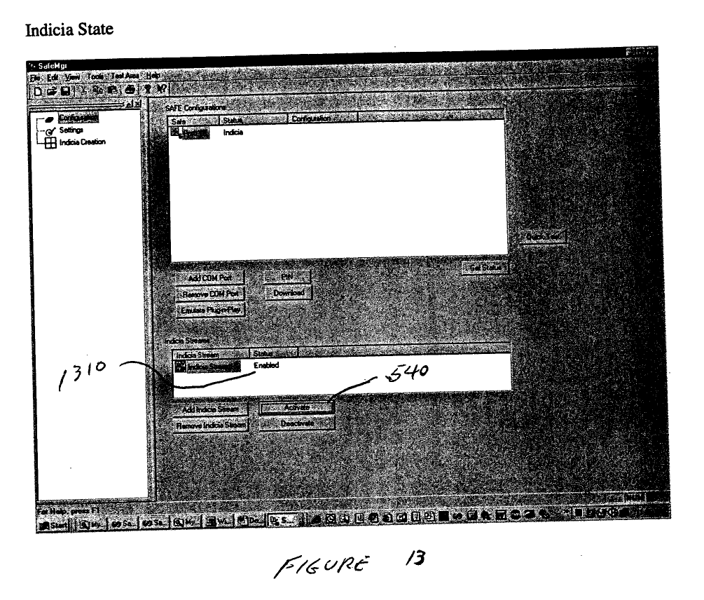

Turning to FIG. 12, the user may then press the Add Indicia Stream button 535 so that any ready PSD's may produce indicia. An indicia stream is first initiated in an inactive or disabled state 1210. Upon pressing the activate button 540, the indicia stream is enabled 1310 and indicia is produced by the PSD 255.

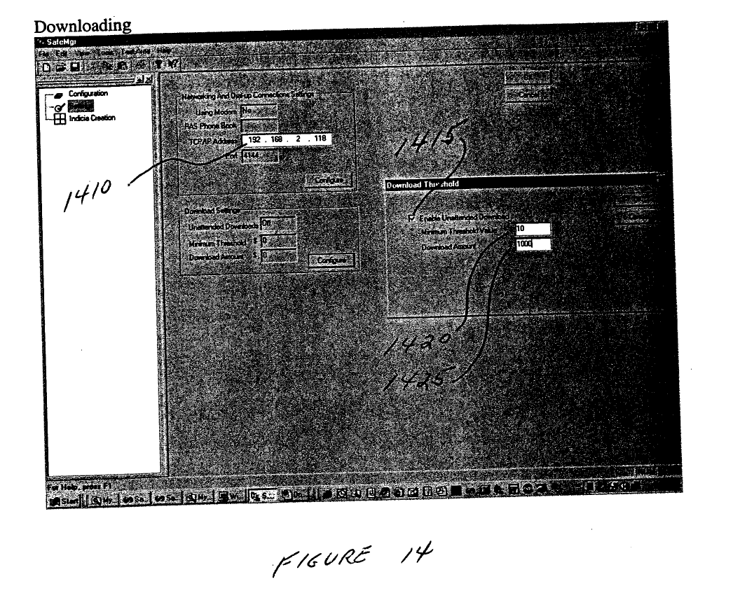

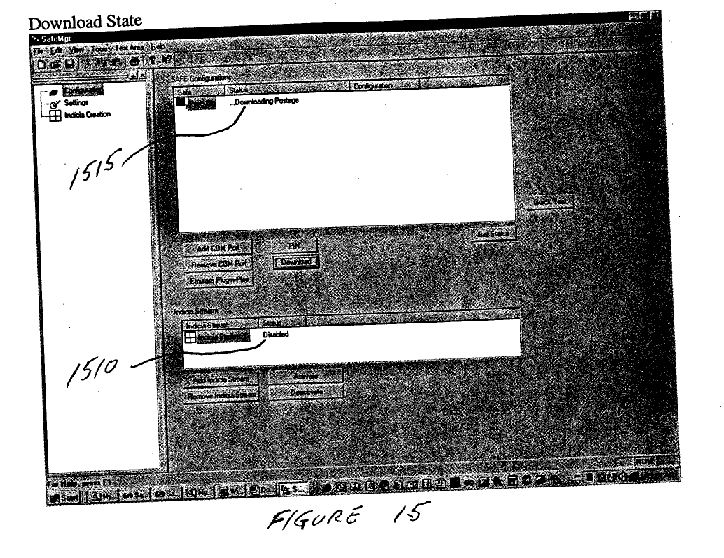

Pressing the Download button 520 (FIG. 5) allows the user to enable and configure the automatic download function as shown in FIG. 14. Using this careen, a user may specify a TCP/IP address 1410 of a server that provides funds downloads and may enable automatic downloads 1415. The user may also specify a threshold 1420 for initiating an automatic download and specify an download amount 1425. As shown in FIG. 15, once the download threshold is reached by a PSD, the indicia stream for that PSD is disabled and postage is downloaded to the PSD 1515.

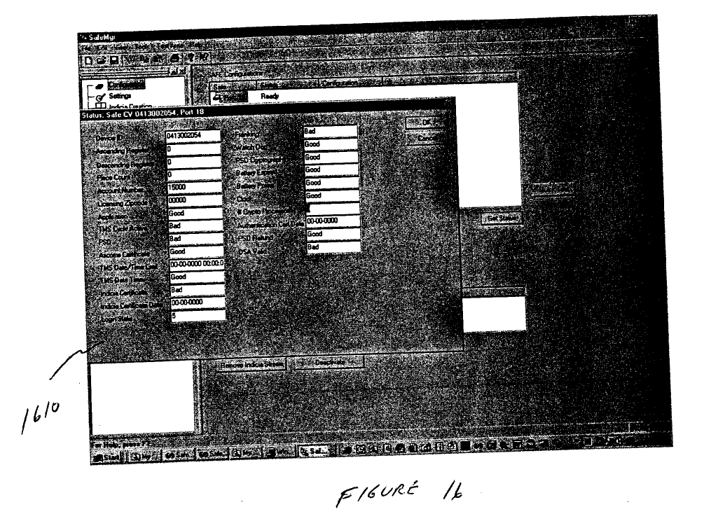

Turning to FIG. 16, pressing the Get Status button 525 (FIG. 5) displays a screen 1610 with various status indications of the selected PSD.

Thus, the present invention provides a high level API that is intuitive and easy to use when utilizing one or more PSD's for printing indicia. The interface also provides a communication path between the PSD's and a service provider for funds replenishment.

It should be understood that the foregoing description is only illustrative of the invention. Various alternatives and modifications can be devised by those skilled in the art without departing from the invention. Accordingly, the present invention is intended to embrace all such alternatives, modifications and variances.

1. An application program interface (API) for controlling one or more postal security devices (PSD's) in a system for producing indicia, comprising:
a function for adding a communication port for one or more PSD's and automatically initializing the one or more PSD's;
a function adding an indicia stream to the one or more initialized PSD's to cause the one or more initialized PSD's to generate an indicia string;
a function for activating or deactivating the indicia stream; and
a function for enabling an automatic funds download to the one or more initialized PSD's.

2. The API of claim 1, wherein the function for adding a communication port for one or more PSD's and automatically initializing the one or more PSD's automatically detects the presence of a PSD and loads programs into the PSD.
